(19) United States
(12) Patent Application Publication
(10) Pub. No.: US 2026/0298106 A1
(43) Pub. Date: Oct. 1, 2026

(54) SIGN DETECTION DEVICE, SIGN DETECTION METHOD, AND SIGN DETECTION PROGRAM

(71) Applicants: MITSUBISHI HEAVY INDUSTRIES, LTD., Tokyo (JP); TOKYO UNIVERSITY OF SCIENCE FOUNDATION, Tokyo (JP)

(72) Inventors: Tomohito NAKAMORI, Tokyo (JP); Hiroshi GOTODA, Tokyo (JP); Eisuke NAKAHAMA, Tokyo (JP)

(73) Assignees: MITSUBISHI HEAVY INDUSTRIES, LTD., Tokyo (JP); TOKYO UNIVERSITY OF SCIENCE FOUNDATION, Tokyo (JP)

(21) Appl. No.: 19/489,101

(22) PCT Filed: Feb. 21, 2024
(86) PCT No.: PCT/JP2024/006186

§ 371 Date: Dec. 1, 2025

(30) Foreign Application Priority Data
Aug. 31, 2023 (JP) 2023-140702

(51) Int. Cl. F01D 21/14; F02C 3/22

(52) U.S. Cl. CPC F01D 21/14; F02C 3/22; F05D 2240/35; F05D 2270/71

(57) ABSTRACT

The present application relates to a sign detection device for detecting a sign of oscillation generated in a combustor of a gas turbine. The device detects a sign on the basis of a first index and a second index. The first index is calculated as an index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors. The second index is calculated as an index indicating a synchronous property among a plurality of pieces of time-series data obtained from a second sensor and a third sensor disposed respectively at different positions of the combustor from one another.

### TECHNICAL FIELD

The present disclosure relates to a sign detection device, a sign detection method, and a sign detection program.

The present application claims priority based on Japanese Patent Application No. 2023-0140702 filed on Aug. 31, 2023 with the Japanese Patent Office, the contents of which are incorporated herein by reference.

### BACKGROUND ART

In a gas turbine driven by combustion gas generated by combusting a fuel, unstable oscillation (sudden oscillation) with a sudden change trend may occur in a combustor.

Such a sudden change oscillation reaches a limit cycle in a short period of time after occurrence of an oscillation increase. When a sudden change oscillation reaches a limit cycle, the sudden change oscillation may cause a trip or a great load applied to equipment.

Thus, it is desirable to avoid such a sudden change oscillation in an earlier stage. However, in such a sudden change oscillation, an oscillation increase occurs in a short period of time before reaching the limit cycle, and thus it may be difficult to avoid a sudden change oscillation by a control after an oscillation increase is actually detected. Thus, in order to avoid a sudden change oscillation, it is necessary to detect a sign of the sudden change oscillation sufficiently in advance of occurrence of the sudden change oscillation. For instance, Patent Document 1 discloses a technique for detecting a sign of coupled combustion oscillation that occurs in a plurality of combustors of a gas turbine on the basis of parameters indicating the correlation between physical quantities obtained from respective sensors disposed on the plurality of combustors.

### CITATION LIST

### Patent Literature

Patent Document 1: JP2021-162397A

### SUMMARY

### Problems to be Solved

In Patent Document 1, the detection target is a sign of combustion oscillation having a frequency range of a couple of hundreds Hz that occur coupled in a plurality of combustors, and it is not capable of detecting a sign of combustion oscillation that occur at a different frequency range in a single combustor. Recently, usage of a fuel that combusts at a higher speed such as hydrogen gas is considered for a gas turbine. Hydrogen has a higher combustion speed compared to natural gas or the like that has been conventionally used as a 5fuel, and thus the length of flame formed in a combustor becomes shorter, and combustion oscillation in a higher frequency range is more likely to occur.

At least one embodiment of the present disclosure was made in view of the above, and an object is to provide a sign detection device, a sign detection method, and a sign detection program capable of preferably detecting a sign of combustion oscillation having various characteristics.

### Solution to the Problems

To solve the above problem, a sign detection device according to at least one embodiment of the present disclosure is a sign detection device for detecting a sign of oscillation generated in a combustor of a gas turbine and includes: a first index calculation part for calculating a first index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors; a second index calculation part for calculating a second index indicating a synchronous property among a plurality of pieces of time-series data obtained from a second sensor and a third sensor disposed respectively at different positions of the combustor from one another; and a sign detection part for detecting the sign on the basis of the first index and the second index.

To solve the above problem, a sign detection method according to at least one embodiment of the present disclosure is a sign detection method for detecting a sign of oscillation generated in a combustor of a gas turbine, and includes: a step of calculating a first index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors; a step of calculating a second index indicating a synchronous property among a plurality of pieces of time-series data obtained from a second sensor and a third sensor disposed respectively at different positions of the combustor from one another; and a step of detecting the sign on the basis of the first index and the second index.

To solve the above problem, a sign detection program according to at least one embodiment of the present disclosure is a sign detection program for detecting a sign of oscillation generated in a combustor of a gas turbine, and is capable of executing, with a computer apparatus: a step of calculating a first index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors; a step of calculating a second index indicating a synchronous property among a plurality of pieces of time-series data obtained from a second sensor and a third sensor disposed respectively at different positions of the combustor from one another; and a step of detecting the sign on the basis of the first index and the second index.

### Advantageous Effects

According to at least one embodiment of the present disclosure, it is possible to provide a sign detection device, a sign detection method, and a sign detection program capable of detecting a sign of combustion oscillation having various characteristics preferably.

### BRIEF DESCRIPTION OF DRAWINGS

FIG. 1 is a schematic cross-sectional view, taken along the turbine axis, of the vicinity of a combustor included in a gas turbine according to an embodiment.

FIG. 2 is a cross-sectional view taken along line A-A in FIG. 1.

FIG. 3 is a block configuration diagram of a sign detection device according to an embodiment.

FIG. 4 is an example of a multi-dimensional vector in a D-dimensional topological space.

FIG. 5 is an example of a recurrence plot corresponding to FIG. 4.

FIG. 6 is a diagram showing the corresponding relationship between the distribution of regression points in a recurrence plot and the index De.

FIG. 7 is a diagram showing the corresponding relationship between the distribution of regression points in a recurrence plot and the index La.

FIG. 8 is an example of distribution of regression points in a joint recurrence plot.

FIG. 9 is an explanatory diagram for obtaining a cross recurrence plot from the distance between data points of two pieces of time-series data on the topological space.

FIG. 10 is a conceptual diagram of the order parameter K.

FIG. 11A is a diagram of past data of the physical quantity obtained from the first sensor when combustion oscillation having a relatively low frequency range near 3000 Hz is observed.

FIG. 11B is a recurrence plot corresponding to FIG. 11A.

FIG. 11C is a diagram showing an example of a clustering result corresponding to N pieces of data defined by the average values μDe and μLa respectively corresponding to the indexes De and La, corresponding to FIG. 11A.

FIG. 12 is a diagram showing an example of a result of clustering of past data of the average value μCD corresponding to the index CD being the second index when combustion oscillation having a relatively high frequency range near 4500 Hz is observed.

### DETAILED DESCRIPTION

Some embodiments will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

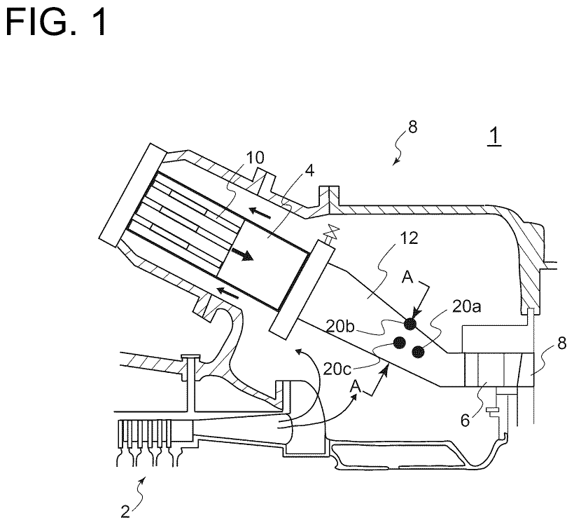

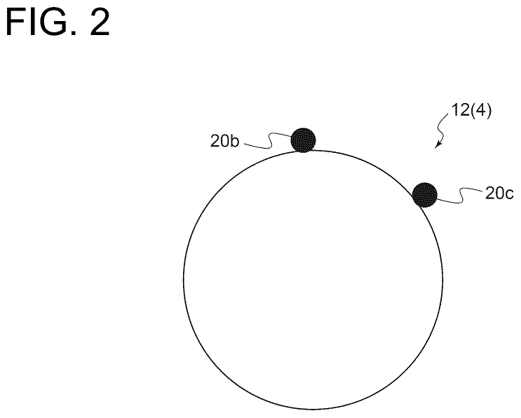

Firstly, a gas turbine 1 being a detection target of a sign detection device according to at least one embodiment of the present disclosure will be described with reference to FIG. 1. FIG. 1 is a schematic cross-sectional view, taken along the turbine axis, of the vicinity of a combustor 4 of a gas turbine 1 according to an embodiment. FIG. 2 is a cross-sectional view taken along line A-A in FIG. 1.

The gas turbine 1 includes a compressor 2, a combustor 4, a stationary vane 6, and a rotor blade 8. The combustor 4 is a can type combustor, and a plurality of combustors 4 are disposed along the circumferential direction of the turbine shaft. The plurality of combustors 4 have a similar configuration to one another, and FIG. 1 shows one of the plurality of combustors 4 as a representative. Each of the plurality of combustors 4 has a combustion nozzle 10 and a transition piece 12.

Furthermore, at least one sensor for detecting a sign with a sign detection device 100 described below is disposed on the combustor 4 of the gas turbine 1. In FIG. 1, as the sensor, three sensors (first sensor 20a, second sensor 20b, third sensor 20c) are disposed on the transition piece 12 of the combustor 4. In the present embodiment, for the convenience of explanation, the first sensor 20a, the second sensor 20b, and the third sensor 20c are disposed on different positions from one another. Nevertheless, it is sufficient if the second sensor 20b and the third sensor 20c are disposed on different positions from one another (that is, the first sensor 20a may be disposed on the same position as the second sensor 20b or the third sensor 20c). Furthermore, the second sensor 20b and the third sensor 20c may be arranged along the circumferential direction about the center axis of the transition piece 12 of the combustor 4 as depicted in FIG. 2, or may be arranged along the axial direction.

The second sensor 20b or the third sensor 20c may also function as the first sensor 20a.

The above sensors (the first sensor 20a, the second sensor 20b, and the third sensor 20c) are capable of measuring a physical quantity at the respective positions. The physical quantity that is measurable by the sensors are not limited as long as the physical quantity is related to occurrence of combustion oscillation. For instance, the physical quantity is at least one of pressure, distortion, acceleration, velocity, or displacement.

Next, the sign detection device 100 for detecting a sign of combustion oscillation of the gas turbine 1 having the above configuration will be described. The sign detection device 100 is a computer including, for instance, a central processing unit (CPU), a random access memory (RAM), a read only memory (ROM), and the like. In the sign detection device 100, the processor (CPU) executes the programs stored in the memory (RAM or ROM) to realize various functions described below.

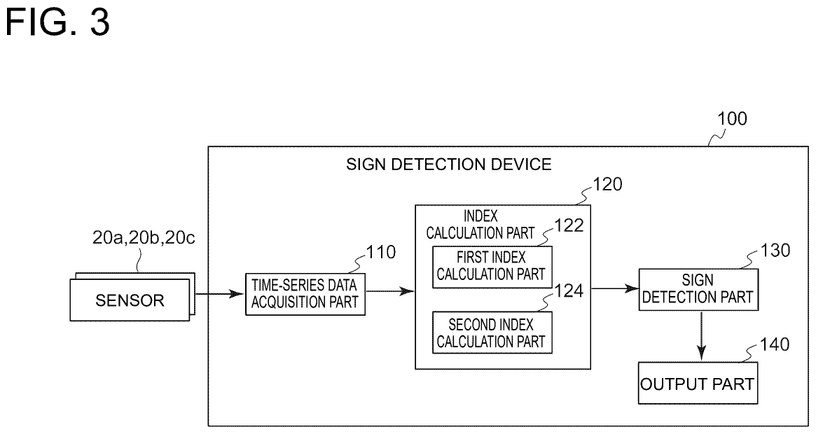

FIG. 3 is a block configuration diagram of a sign detection device 100 according to an embodiment. The sign detection device 100 includes a time series data acquisition part 110, an index calculation part 120, a sign detection part 130, and an output part 140.

The time series data acquisition part 110 is configured to obtain the time series data of the physical quantity from each sensor (the first sensor 20a, the second sensor 20b, and the third sensor 20c). The time series data includes a plurality of pieces of data sampled at a plurality of timings (that is, at a predetermined sampling period) in the unit time of the recent past.

The index calculation part 120 is a component for calculating the index for determining presence or absence of a sign of combustion oscillation on the basis of the time series data obtained by the time series data acquisition part 110. In the present embodiment, the index calculation part 120 is capable of calculating the first index I1 and the second index 12 as the index, and includes a first index calculation part 122 for calculating the first index I1 and a second index calculation part 124 for calculating the second index I2 (the specific method of calculating the first index I1 and the second index I2 will be described below).

The sign detection part 130 is a component for detecting a sign of combustion oscillation on the basis of the index calculated by the index calculation part 120. The sign detection part 130 handles both of the first index I1 calculated by the first index calculation part 122 and the second index I2 calculated by the second index calculation part 124 as the index calculated by the index calculation part 120, and thereby capable of detecting a sign of combustion oscillation having a variety of characteristics preferably. That is, the combustion oscillation to be detected may have different characteristics depending on the frequency range, for instance. A combustion oscillation is more sensitive to the first index I1 and less sensitive to the second index I2, while another combustion oscillation is less sensitive to the first index I1 and more sensitive to the second index I2. Thus, if a sign is detected on the basis of only one of the first index I1 or the second index I2, such detection may lead to a failure depending on the characteristics of the combustion oscillation. Thus, by detecting a sign on the basis of both of the first index I1 and the second index I2, the sign detection part 130 is capable of detecting combustion oscillation having a variety of characteristics preferably.

The output part 140 is a component for performing various outputs on the basis of the detection result of the sign detection part 130. The output content of the output part 140 may include, in addition to various types of data indicating a sign detected by the sign detection part 130, for instance, time series data obtained by the time series data acquisition part 110 and related data such as the index calculated by the index calculation part 120. Furthermore, the output part 140 may output, if a sign is detected by the sign detection part 130, a display or a sound meaning an alert for informing of the detection to an operator, or output automatically a control signal for avoiding combustion oscillation to another control device.

Next, the method of calculating the index with the index calculation part 120 will be described specifically. Firstly, the first index calculation part 122 of the index calculation part 120 calculates the first index I1 as the index. That is, the first index I1 is calculated on the basis of the time series data obtained from the first sensor 20a disposed on the combustor 4. That is, the first index I1 is an index that can be calculated from data obtained from a single sensor. The first index I1 is calculated as an index related to at least one of a regression property among a plurality of multi-dimensional vectors including, as vector components, multiple pieces of data included in time-series data obtained from the first sensor 20a, or an intermittency property among the plurality of multi-dimensional vectors.

Herein, a regression property refers to temporal continuation of similarity between pieces of data of two different times in a single time series signal (e.g., similarity continues between time tᵢ and time (tᵢ+Δt), time (tᵢ₊₁) and time (tᵢ₊₁+Δt), time (tᵢ₊₂) and time (tᵢ₊₂+Δt)). An intermittency property refers to continuation of similarity between pieces of data of a time and a plurality of times temporarily continuing to the time in a single time series signal (e.g., similarity continues between time tᵢ and time (tᵢ+Δt), time tᵢ and time (tᵢ₊₁+Δt), time tᵢ and time (tᵢ₊₂+Δt)).

Specifically, the time series data x(tᵢ) (i=1, 2, . . . , N) obtained from the first sensor 20a by the time series data acquisition part 110 includes N pieces of measurement data obtained in each predetermined sampling period. The first index calculation part 122 defines delay time t and a multi-dimensional vector X (tᵢ) being a position vector in the D dimensional topological space from the time series data x(tᵢ) (i=1, 2, . . . , N). Specifically, the multi-dimensional vector X(tᵢ) is defined by the following equation.

$$X ( {t}_{i} ) = \{ x ( {t}_{i} ) , x ( {t}_{i} + 1 ) , … , x ( {t}_{i} + ( D - 1 ) τ ) \} \qquad ( 1 )$$

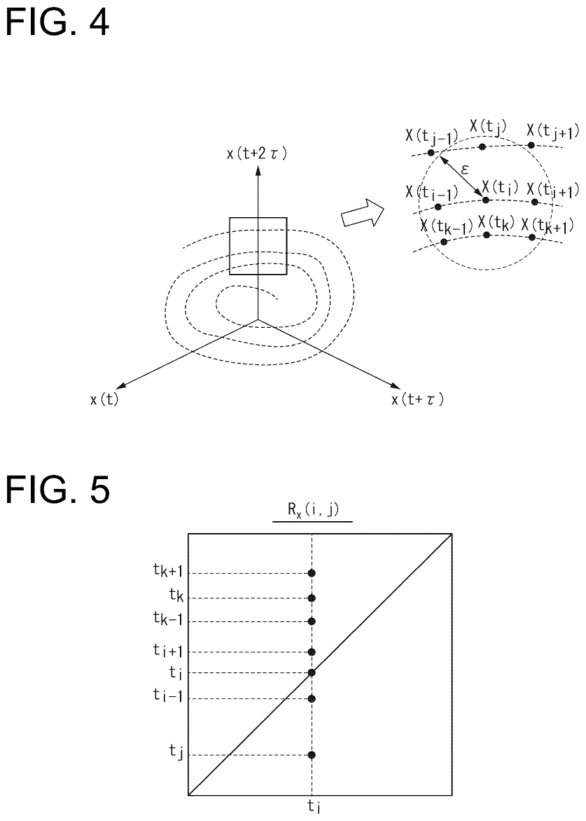

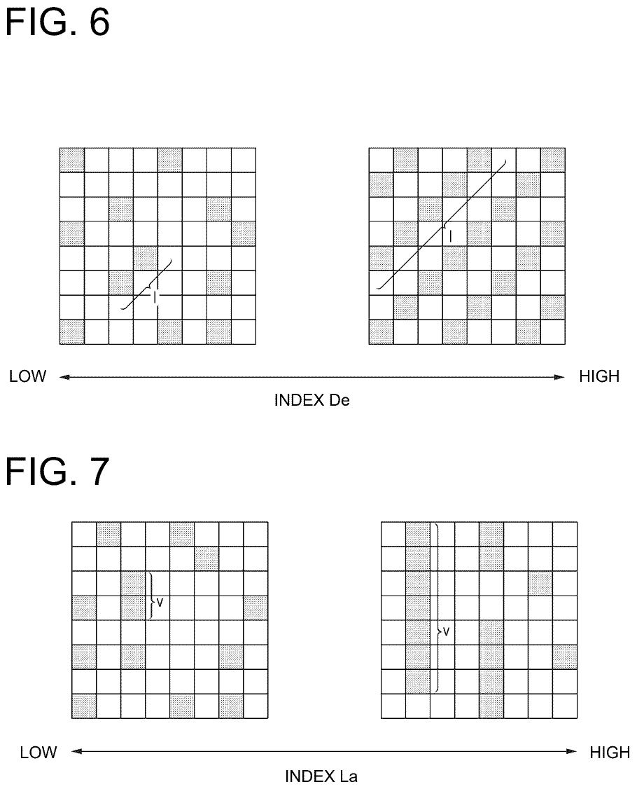

FIG. 4 is an example of a multi-dimensional vector X(tᵢ) in a D-dimensional topological space. FIG. 5 is an example of a recurrence plot corresponding to FIG. 4. The D-dimensional topological space is a multi-dimensional space where the axes are represented as x(t), x(t+τ), x(t+2τ), . . . . FIG. 4 illustrates a case of D=3, which can be expressed on a drawing. The first index calculation part 122 obtains a recurrence plot on the basis of the next equation in such a D-dimensional topological space, on the basis of the magnitude relationship between a threshold value ε and a Euclidean distance X(tᵢ)−X(tⱼ) between the multi-dimensional vectors corresponding to two arbitrary times (t₁, tⱼ).

$$R ( i , j ) = \{ \begin{matrix}1 if ‖ X ( {t}_{i} ) - X ( {t}_{j} ) ‖ < ε \\ 0 otherwise\end{matrix} \qquad ( 2 )$$

In the recurrence plot obtained as described above, as depicted in FIG. 5, the absolute value of the Euclidean distance X(tᵢ)−X(tⱼ) is less than the threshold value ε, which enhances the regression points having a similar behavior.

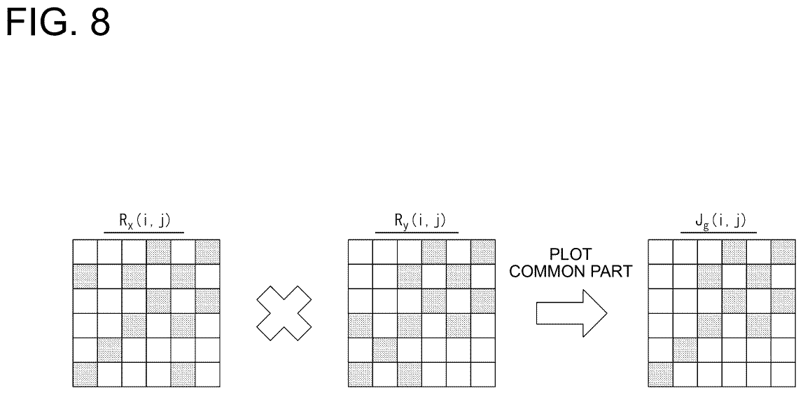

The first index calculation part 122 is capable of calculating, as an example of the first index I1 related to the regression property, an index De (Determinism) being a ratio of the regression point constituting a diagonal structure included in the recurrence plot to all regression points. FIG. 6 is a diagram showing the corresponding relationship between the distribution of regression points in the recurrence plot and the index De. FIG. 6 shows a representative diagonal structure, indicating the length with a sign I. In a case where the index De is low, the number and the length of the diagonal structures included in the distribution of the regression points in the recurrence plot become smaller, and the distribution of the regression points becomes closer to random. Contrary, in a case where the index De is high, the number and the length of the diagonal structures included in the distribution of the regression points in the recurrence plot become greater. As described above, the regression property means that a similar behavior occurs repetitively each predetermined period, and it is possible to handle the regression property as an index related to the combustion oscillation. The index De related to the regression property can be, for instance, defined quantitatively by the following equation.

$${D}_{e} = \frac{{\sum }_{l - {l}_{min}}^{{N}_{p}} l P ( l )}{{\sum }_{l = 1}^{{N}_{p}} lP ( l )} \qquad ( 3 )$$

The index De defined by the equation (3) may be a value in the range of 0≤De≤1, and becomes closer to one as the periodicity becomes higher.

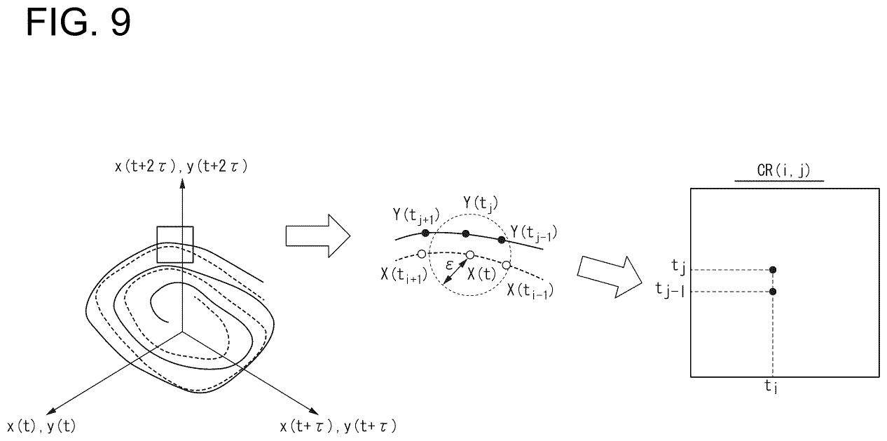

Furthermore, the first index calculation part 122 is capable of calculating, as an example of the first index I1 related to the intermittency property, an index La (Laminarity) being a ratio of the regression point constituting a vertical structure or a horizontal structure included in the recurrence plot to all regression points. Herein, FIG. 7 is a diagram showing the corresponding relationship between the distribution of regression points in the recurrence plot and the index La. FIG. 7 shows a representative vertical structure, indicating the length with a sign ‘v’. In a case where the index La is low, the number and the length of the vertical structures included in the distribution of the regression points in the recurrence plot become smaller, and the distribution of the regression points becomes closer to random. On the other hand, in a case where the index La is high, the number and the length of the vertical structures included in the distribution of the regression points in the recurrence plot become greater. As described above, the intermittency property means that a similar behavior occurs repetitively between continuous times, and it is possible to handle the intermittency property as an index related to the combustion oscillation. The index La related to the intermittency property can be, for instance, defined quantitatively by the following equation.

$${L}_{a} = \frac{{\sum }_{v = {v}_{min}}^{{N}_{p}} v P ( v )}{{\sum }_{v - 1}^{N} vP ( v )} \qquad ( 4 )$$

The index De defined by the above equation (4) may be a value in the range of 0≤La≤1, and becomes closer to one as the frequency of the periodic function becomes smaller.

Next, the second index calculation part 124 of the index calculation part 120 calculates the second index I2 as the index. That is, the second index I2 is calculated on the basis of the synchronous property of the plurality of pieces of time series data obtained from the second sensor 20b and the third sensor 20c disposed on the different positions of the combustor 4 from one another. That is, the second index I2 is an index that can be calculated from data obtained from a plurality of sensors disposed on different positions from one another.

The second index calculation part 124 is capable of calculating, as an example of the second index I2 related to the synchronous property, an index De (Determinism) being a ratio of the regression point constituting a diagonal structure included in the joint recurrence plot to all regression points. A joint recurrence plot is obtained by expanding a recurrence plot obtained on the basis of the time series data obtained from the single first sensor 20a described above to apply the same to the plurality of pieces of time series data obtained from the second sensor 20b and the third sensor 20c (multivariate time series data).

Specifically, separately considering the recursiveness of the trajectory of each of the time series data x (tᵢ) (I=1, 2, . . . , N) obtained from the second sensor 20b and the time series data y (tᵢ) (I=1, 2, . . . , N) obtained from the third sensor 20c in the topological space, if both recurse at the same time, the regression points are plotted in black on the corresponding coordinate, and if otherwise the regression points are plotted in white. Specifically, the joint recurrence plot JR (I, j) is defined by the following equation (herein, i, j=1, 2, . . . , Np. Herein, Np is the number of pieces of data on the topological space).

$${J}_{R} = Θ ( {ϵ}_{x} - ‖ X ( {t}_{i} ) - X ( {t}_{j} ) ‖ ) Θ ( {ϵ}_{y} - ‖ Y ( {t}_{i} ) - Y ( {t}_{j} ) ‖ ) = {R}_{x} ( i , j ) {R}_{y} ( i , j ) \qquad ( 5 )$$

$$( i , j = 1 , 2 , … , Np )$$

Herein, X(tᵢ)={x(tᵢ), x(tᵢ+τ), . . . , x(tᵢ+(D−1)τ)}, Y(tᵢ)={y(tᵢ), y(tᵢ+τ), . . . , y(tᵢ+(D−1)τ)}. D is embedding dimension, t is delay time, & is threshold, and ⊙ is Heaviside function.

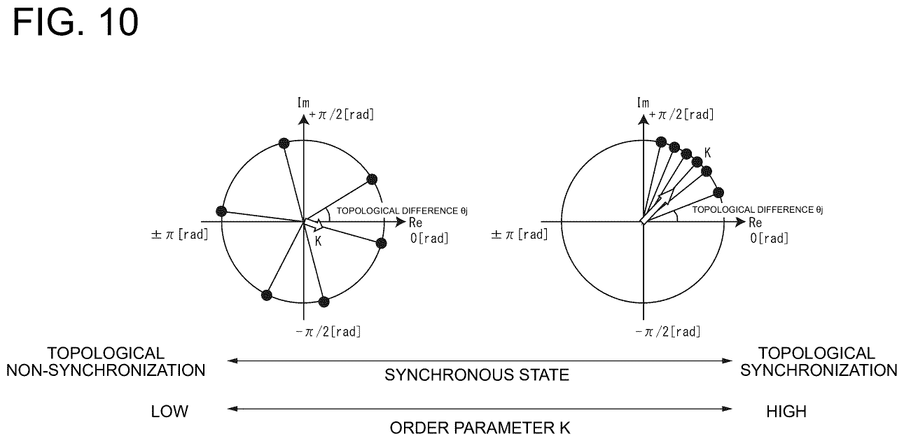

Herein, FIG. 8 is an example of distribution of regression points on the joint recurrence plot. As depicted in FIG. 8, the joint recurrence plot JR Jr (i,j) corresponds to a plot of shared parts with a recurrence plot Rx (i,j) created on the basis of the time series data X(tᵢ)={x(tᵢ), x(tᵢ+τ), . . . , x(tᵢ+(D−1) τ)} obtained from the second sensor 20b and a recurrence plot Ry (i,j) created on the basis of the time series data Y (tᵢ)={y(tᵢ), y(tᵢ+τ), . . . , y(tᵢ+(D−1) τ)} obtained from the third sensor 20c.

The second index calculation part 124 is capable of calculating, as the second index I2, a decision level JD being a ratio of the regression points constituting a diagonal structure to all regression points, for the above joint recurrence plot JR (i, j). The index JD in the joint recurrence plot Jr (i, j) is determined quantitatively by the following equation.

$${J}_{D} = \frac{{\sum }_{l - {l}_{min}}^{{N}_{p}} l P ( l )}{{\sum }_{l = 1}^{{N}_{p}} lP ( l )} \qquad ( 6 )$$

The second index calculation part 124 is capable of calculating, as an example of the second index I2 related to the synchronous property, an index De (Determinism) being a ratio of the regression point constituting a diagonal structure included in the cross recurrence plot to all regression points. A cross recurrence plot is obtained by expanding a recurrence plot obtained on the basis of the time series data obtained from the single first sensor 20a described above to apply the same to the plurality of pieces of time series data obtained from the second sensor 20b and the third sensor 20c (multivariate time series data).

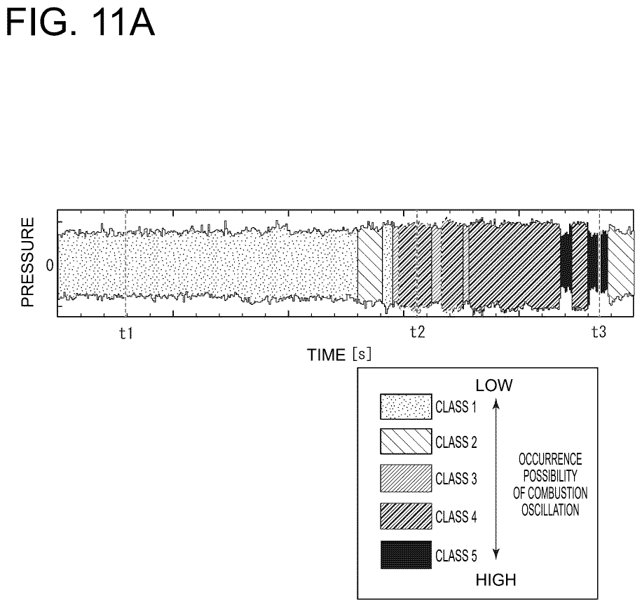

FIG. 9 is an explanatory diagram for obtaining a cross recurrence plot from the distance between data points of two pieces of time-series data on the topological space. Specifically, the time series data x (tᵢ) (i=1, 2, . . . , N) obtained from the second sensor 20b and the time series data y (tᵢ) (i=1, 2, . . . , N) obtained from the third sensor 20c are embedded in a common topological space, and if the distance between the time series data x (ti) and y (ti) in the topological space is close (smaller than the threshold value ¿), the regression points are plotted in black on the corresponding coordinate, and if not, the regression points are plotted in white. Specifically, the cross recurrence plot CR (i, j) is defined by the following equation (i, j=1, 2, . . . , Np. Herein, Np is the number of pieces data on the topological space).

$${C}_{R} = Θ ( ε - ‖ X ( {t}_{i} ) - Y ( {t}_{j} ) ‖ ) \qquad ( 7 )$$

Herein, X (tᵢ)={x(tᵢ), x(tᵢ+τ), . . . , x(tᵢ+(D−1) τ)}, y(tᵢ)={y(tᵢ), y(tᵢ+τ), . . . , y(tᵢ+(D−1) τ)}. D is embedding dimension, τ is delay time, ε is threshold, and ⊙ is Heaviside function.

In the cross recurrence plot, the period in which the distance between the data points on the topological space lasts long, a diagonal structure is formed. Thus, the second index calculation part 124 is capable of calculating, as the second index I2, a decision level CD being a ratio of the regression points constituting the diagonal structure to all regression points, for the above cross recurrence plot CR (i, j). The index CD in the cross recurrence plot CR (i, j) is determined quantitatively by the following equation.

$${C}_{D} = \frac{{\sum }_{l - {l}_{min}}^{{N}_{p}} l P ( l )}{{\sum }_{l = 1}^{{N}_{p}} lP ( l )} \qquad ( 8 )$$

The second index calculation part 124 is capable of calculating, as an example of the second index I2 related to the synchronous property, the order parameter K (Kuramoto order parameter) obtained from a plurality of pieces of time series data. The order parameter K is calculated by applying the time series data x (tᵢ) (i=1, 2, . . . , N) obtained from the second sensor 20b and the time series data y (tᵢ) (i=1, 2, . . . , N) obtained from the third sensor 20c to the following equation.

$$K ( t ) = \frac{1}{N} \vert {\sum }_{j = 1}^{N} {e}^{i {θ}_{j} ( t )} \vert \qquad ( 9 )$$

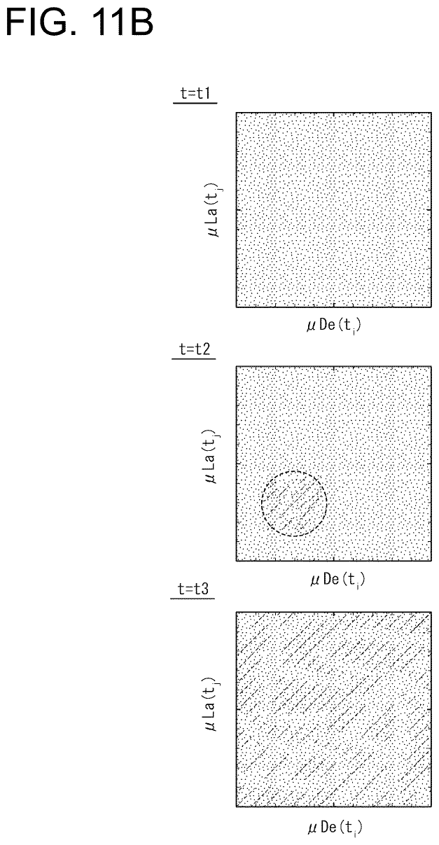

Herein, θj (t) indicates the phase of the i-th oscillator at time ‘t’. The order parameter K indicates the distance between the origin and the gravity coordinate of the oscillator distributed on a unit circle, and may be a value in the range of 0≤K≤1. FIG. 10 is a conceptual diagram of the order parameter K. The order parameter K indicates a value closer to one as it is closer to the synchronous state.

Next, the method of determining presence or absence of a sign by the sign detection part 130 will be described specifically. The sign detection part 130 detects a sign on the basis of both of the first index I1 calculated by the first index calculation part 122 and the second index I2 calculated by the second index calculation part 124. Since the first index I1 and the second index I2 are indexes capable of determining presence or absence of a sign from different perspectives as described above, the sign detection part 130 is capable of preferably detecting a sign which may be overlooked if only one index is used, by performing sign detection based on both of the indexes.

The sign detection part 130 identifies a class corresponding to a sign by applying a classification model to the past data of the first index I1 or the second index I2, and detects a sign on the basis of whether the first index I1 calculated by the first index calculation part 122 and the second index I2 calculated by the second index calculation part 124 belong to the class. The classification model used in the sign detection part 130 can be created by applying clustering to past data. In the present embodiment, the K-means clustering, a type of clustering, is used to create a classification model. Nevertheless, the method of creating a classification model is not limited thereto.

In the K-means clustering, K cluster centroids mk (k=1, 2, . . . , K) are assumed for N pieces of data xᵢ (I=1, 2, . . . , N)=[μDe (tᵢ), μLa (tᵢ)]. Herein, μDe is an average value calculated from a plurality of indexes De, and μLa is an average value calculated from a plurality of indexes La.

Next, the N pieces of data are classified into K clusters so that the objective function J defined by the following equation becomes the minimum. Then, a new centroid mk is calculated for each classified data point, and the same is repeated until the centroid mk no longer changes, thereby identifying the classification corresponding to the K clusters.

$$J = {\sum }_{i = 1}^{N} {\sum }_{k = 1}^{K} {r}_{i k} {‖ {x}_{i} - {m}_{k} ‖}^{2} \qquad ( 10 )$$

Herein, rik is an indicator function and expressed by the following equation.

$${r}_{ik} = \{ \begin{matrix}1 if k = arg {min}_{j} {‖ {x}_{i} - {m}_{k} ‖}^{2} \\ 0 otherwise\end{matrix} \qquad ( 11 )$$

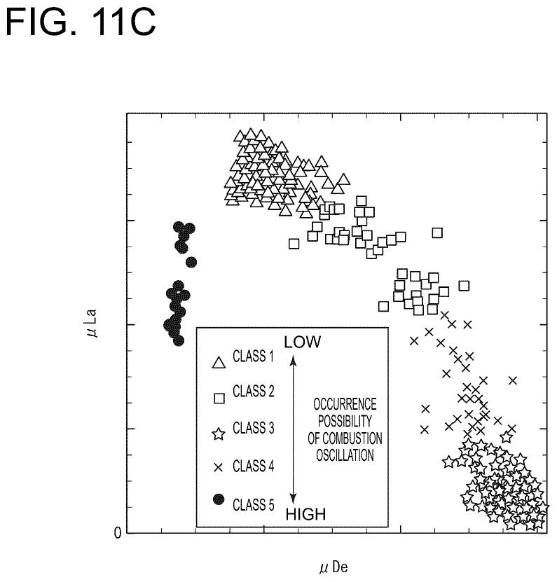

FIG. 11A is a diagram of past data of the physical quantity (pressure value) obtained from the first sensor 20a when combustion oscillation having a relatively low frequency range near 3000 Hz is observed. FIG. 11B is a recurrence plot corresponding to FIG. 11A. FIG. 11C is a diagram showing an example of a clustering result corresponding to N pieces of data defined by the average values μDe and μLa respectively corresponding to the indexes De and La, corresponding to FIG. 11A.

In this example, K=5 is set, and thereby the result of clustering is shown as five classes defined by the magnitude of the possibility of occurrence of combustion oscillation. Class 1 indicates that there is no possibility of occurrence of combustion oscillation, and that the combustion state is stable. Meanwhile, Class 5 is a class indicating the highest possibility of occurrence of combustion oscillation, and that combustion oscillation has actually occurred. Class 2 to Class 4 are classes between Class 1 and Class 5, each indicating a state where combustion oscillation has not actually occurred but the possibility of occurrence of combustion oscillation is high, that is, a sign of combustion oscillation.

At time 1, the data belongs to Class 1 as shown in FIG. 11A. At this time, as shown in FIG. 11B, the data exists randomly as isolated points on the corresponding recurrence plot, and the diagonal structure indicating a sign of combustion oscillation is hardly observed. At time t2, the data belongs to Class 4 as shown in FIG. 11A. At this time, as shown in FIG. 11B, the corresponding recurrence plot shows an increase of the diagonal structure indicating a sign of combustion oscillation compared to time t1 (in particular, the diagonal structure can be partially observed in a region surrounded by broken lines). At time t3, the data belongs to Class 5 as shown in FIG. 11A. At this time, as shown in FIG. 11B, the diagonal structure is observed in a large number over the entire corresponding recurrence plot, and combustion oscillation is actually occurring.

As described above, from the result of clustering analysis using the indexes De and La being the first indexes I, occurrence of combustion oscillation having a frequency range of around 3000 Hz is preferably observed. Meanwhile, although not depicted in FIGS. 11A to 11C, a change due to the combustion oscillation was not observed from the second index I2 calculated on the basis of the past data shown in FIG. 11A. Accordingly, it was found that the second index I2 is less sensitive and the first index I1 is more sensitive with regard to combustion oscillation having a relatively low frequency range of around 3000 Hz.

According to verification by the present inventors, combustion oscillation having a frequency range of around 3000 Hz has a behavior that the oscillation frequency transits to not only a specific frequency in the center but to the frequency around the specific frequency with time (in other words, a behavior of switching rapidly between a plurality of oscillation modes having close oscillation frequencies with one another), and thus the second index I2 related to the synchronous property is less sensitive and the first index I1 related to the regression property and the intermittency property is more sensitive.

From the above result, it was found that it is effective to detect presence or absence of a sign on the basis of the first index I1 with the sign detection part 130 in a case where the combustion oscillation to be detected has a relatively low frequency range. In this case, the sign detection part 130 performs clustering analysis on past data on the basis of the index De and the index La being the first indexes I1 as illustrated in FIGS. 11A to 11C, thereby specifying classes corresponding to the sign state. Then, from the time series data obtained from the actual machine by the time series data acquisition part 110, it is possible to determine presence or absence of a sign of combustion oscillation on the basis of whether the first index I1 calculated by the first index calculation part 122 belongs to the class.

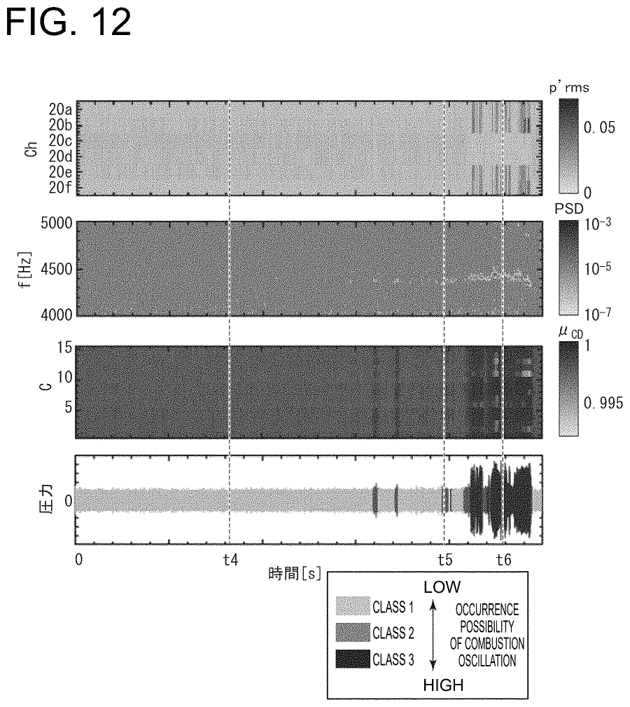

Next, FIG. 12 is a diagram showing an example of a result of clustering of past data of the average value μCD corresponding to the index CD (see the above equation (8)) being the second index I2 when combustion oscillation having a relatively high frequency range near 4500 Hz is observed. In this example, K=3 is set, and thereby the result of clustering is shown as three classes defined by the magnitude of the possibility of combustion oscillation. Class 1 indicates that there is no possibility of combustion oscillation, and that the combustion state is stable. Meanwhile, Class 3 is a class indicating the highest possibility of combustion oscillation, and that combustion oscillation has actually occurred. Class 2 is a class between Class 1 and Class 3, indicating a state where combustion oscillation has not actually occurred yet but the possibility of occurrence of combustion oscillation is high, that is, a sign of combustion oscillation.

In the example illustrated in FIG. 12, in addition to the above described first sensor 20a, the second sensor 20b, and the third sensor 20c, the index CD is calculated on the basis of the pressures from other sensors 20d to 20f as a plurality of sensors capable of obtaining a physical quantity (pressure).

As shown in FIG. 12, at time t4, the data belongs to Class 1. At this time, the index CD calculated from the cross recurrence plot shows a small correlation among the pieces of time series data obtained from the respective sensors, which means that combustion oscillation is not occurring. At time t5, the data belongs to Class 2. At this time, the index CD calculated from the cross recurrence plot shows an increase in the correlation among the pieces of time series data obtained from the respective sensors, which means that there is a sign of combustion oscillation. At time t6, the data belongs to Class 3. At this time, the index CD calculated from the cross recurrence plot shows a further increase in the correlation among the pieces of time series data obtained from the respective sensors, which means that combustion oscillation is occurring.

As described above, from the result of clustering analysis using the index CD being the second index I2, occurrence of combustion oscillation having a frequency range of around 4500 Hz is preferably observed. Meanwhile, although not depicted in FIG. 12, a change due to the combustion oscillation was not observed from the first index I1 calculated on the basis of the past data. Accordingly, it was found that the first index I1 is less sensitive and the second index I2 is more sensitive with regard to combustion oscillation having a relatively high frequency range of around 4500 Hz.

According to verification by the present inventors, combustion oscillation having a frequency range of around 3000 Hz has a behavior that the oscillation frequency transits to not only a specific frequency in the center but to the frequency around the specific frequency with time (in other words, a behavior of switching rapidly between a plurality of oscillation modes having close oscillation frequencies with one another), and thus the second index I2 related to the synchronous property is less sensitive and the first index I1 related to the regression property and the intermittency property is more sensitive.

From the above result, it was found that it is effective to detect presence or absence of a sign on the basis of the second index I2 with the sign detection part 130 in a case where the combustion oscillation to be detected has a relatively high frequency range. In this case, the sign detection part 130 performs clustering analysis on past data on the basis of the index CD being the second indexes 12 as illustrated in FIGS. 12, thereby specifying classes corresponding to the sign state. Then, from the time series data obtained from the actual machine by the time series data acquisition part 110, it is possible to determine presence or absence of a sign of combustion oscillation on the basis of whether the second index I2 calculated by the second index calculation part 124 belongs to the class.

As described above, the sign detection part 130 performs sign detection on the basis of both of the first index I1 calculated on the basis of the time series data obtained from the first sensor 20a and the second index I2 calculated on the basis of a plurality of pieces of time series data obtained from the second sensor 20b and the third sensor 20c. In the former, the first index I1 indicating at least one of the regression property or the intermittency property of each data included in the time series data is used as an index for detecting a sign, on the basis of a plurality of pieces of data included in the time series data obtained by a single sensor. In the latter, the second index I2 indicating the synchronous property among a plurality of pieces of time series data obtained from a plurality of sensors disposed on different positions from one another is used as an index for detecting a sign. By performing sign detection on the basis of the first index I1 and the second index I2 capable of evaluating combustion oscillation from different perspectives, it is possible to detect combustion oscillation having various oscillation characteristics early in a sign stage.

It is possible to replace a constituent element of the above embodiment with a known constituent element without departing from the scope of the present disclosure, and the above embodiments may be combined appropriately.

The contents described in the above respective embodiments can be understood as follows, for instance.

(1) A sign detection device according to at least one aspect is a sign detection device for detecting a sign of oscillation generated in a combustor of a gas turbine and includes: a first index calculation part for calculating a first index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors; a second index calculation part for calculating a second index indicating a synchronous property among a plurality of pieces of time-series data obtained from a second sensor and a third sensor disposed respectively at different positions of the combustor from one another; and a sign detection part for detecting the sign on the basis of the first index and the second index.

According to the above aspect (1), sign detection is performed on the basis of both of the first index calculated on the basis of the time series data obtained from the first sensor and the second index calculated on the basis of a plurality of pieces of time series data obtained from the second sensor and the third sensor. In the former, the first index indicating at least one of the regression property or the intermittency property of each data included in the time series is used as an index for detecting a sign, on the basis of a plurality of pieces of data included in the time series data obtained by a single sensor. In the latter, the second index indicating the synchronous property among a plurality of pieces of time series data obtained by a plurality of sensors disposed on different positions from one another is used as an index for detecting a sign. By performing sign detection on the basis of the first index and the second index capable of evaluating combustion oscillation from different perspectives, it is possible to detect combustion oscillation having various oscillation characteristics early in a sign stage.

(2) In another aspect, in the above aspect (1), the sign detection part is configured to identify a class corresponding to the sign by applying a classification model to past data of the first index or the second index and detect the sign on the basis of whether the first index or the second index belongs to the class.

According to the above aspect (2), it is possible to detect presence or absence of a sign on the basis of whether each data included in the time series data obtained from the sensor belongs to a class identified by applying a classification to the past data of the first index or the second index.

(3) In another aspect, in the above aspect (1) or (2), the first index calculation part is configured to calculate the first index indicating the regression property as a parameter indicating a ratio of a regression point constituting a diagonal structure included in a recurrence plot corresponding to the plurality of multi-dimensional vectors to all regression points.

According to the above aspect (3), a recurrence plot corresponding to the plurality of multi-dimensional vectors including, as vector components, a plurality of pieces of data included in the time series data obtained from the first sensor is created. The first index indicating a regression property is calculated quantitatively as a parameter indicating a ratio of the regression point constituting the diagonal structure included in the recurrence plot to all regression points (e.g., Determinism of the recurrence plot).

(4) In another aspect, in any one of the above aspects (1) to (3), the first index calculation part is configured to calculate the first index indicating the intermittency property as a parameter indicating a ratio of a regression point constituting a vertical structure or a horizontal structure included in a recurrence plot corresponding to the plurality of multi-dimensional vectors to all regression points.

According to the above aspect (4), a recurrence plot corresponding to the plurality of multi-dimensional vectors including, as vector components, a plurality of pieces of data included in the time series data obtained from the first sensor is created. The first index indicating an intermittency property is calculated quantitatively as a parameter indicating a ratio of the regression point constituting the vertical structure or the horizontal structure included in the recurrence plot to all regression points (e.g., Laminarity of the recurrence plot).

(5) In another aspect, in any one of the above aspects (1) to (4), the second index calculation part is configured to calculate the second index as at least one of an order parameter obtained from the plurality of pieces of time-series data, a parameter indicating a ratio of a regression point forming a diagonal structure included in a joint recurrence plot obtained from the plurality of pieces of time-series data to all regression points, or a parameter indicating a ratio of a regression point forming a diagonal structure included in a cross recurrence plot obtained from the plurality of pieces of time-series data to all regression points.

According to the above aspect (5), the second index is calculated quantitatively as the order parameter obtained from the plurality of pieces of time series data obtained from the second sensor and the third sensor, or a parameter indicating a ratio of the regression point constituting the diagonal structure included in the joint recurrence plot or the cross recurrence plot to all regression points (e.g., Determinism of the joint recurrence plot or the cross recurrence plot).

(6) In another aspect, in any one of the above aspects (1) to (5), the second sensor and the third sensor are disposed along a circumferential direction with respect to a center axis of the combustor.

According to the above aspect (6), the second sensor and the third sensor for obtaining the time series data used in calculation of the second index are disposed along the circumferential direction with respect to the center axis of the combustor, and thereby it is possible to obtain the time series data at different positions from one another.

A sign detection method according to at least one aspect is a sign detection method for detecting a sign of oscillation generated in a combustor of a gas turbine and includes: a step of calculating a first index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors; a step of calculating a second index indicating a synchronous property among a plurality of pieces of time-series data obtained from a second sensor and a third sensor disposed respectively at different positions of the combustor from one another; and a step of detecting the sign on the basis of the first index and the second index.

According to the above aspect (7), sign detection is performed on the basis of both of the first index calculated on the basis of the time series data obtained from the first sensor and the second index calculated on the basis of a plurality of pieces of time series data obtained from the second sensor and the third sensor. In the former, the first index indicating at least one of the regression property or the intermittency property of each data included in the time series is used as an index for detecting a sign, on the basis of a plurality of pieces of data included in the time series data obtained by a single sensor. In the latter, the second index indicating the synchronous property among a plurality of pieces of time series data obtained from a plurality of sensors disposed on different positions from one another is used as an index for detecting a sign. By performing sign detection on the basis of the first index and the second index capable of evaluating combustion oscillation from different perspectives, it is possible to detect combustion oscillation having various oscillation characteristics early in a sign stage.

(8) A sign detection program according to an aspect is a sign detection program a for detecting a sign of oscillation generated in a combustor of a gas turbine, and is capable of executing, with a computer apparatus: a step of calculating a first index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors; a step of calculating a second index indicating a synchronous property among a plurality of pieces of time-series data obtained from a second sensor and a third sensor disposed respectively at different positions of the combustor from one another; and a step of detecting the sign on the basis of the first index and the second index.

According to the above aspect (8), sign detection is performed on the basis of both of the first index calculated on the basis of the time series data obtained from the first sensor and the second index calculated on the basis of a plurality of pieces of time series data obtained from the second sensor and the third sensor. In the former, the first index indicating at least one of the regression property or the intermittency property of each data included in the time series is used as an index for detecting a sign, on the basis of a plurality of pieces of data included in the time series data obtained by a single sensor. In the latter, the second index indicating the synchronous property among a plurality of pieces of time series data obtained from a plurality of sensors disposed on different positions from one another is used as an index for detecting a sign. By performing sign detection on the basis of the first index and the second index capable of evaluating combustion oscillation from different perspectives, it is possible to detect combustion oscillation having various oscillation characteristics early in a sign stage.

### REFERENCE SIGNS LIST

1 Gas turbine
2 Compressor
4 Combustor
6 Stationary vane
8 Rotor blade
10 Combustion nozzle
12 Transition piece
20a First sensor
20b Second sensor
20c Third sensor
100 Sign detection device
110 Time-series data acquisition part
120 Index calculation part
130 Sign detection part
140 Output part

1. A sign detection device for detecting a sign of oscillation generated in a combustor of a gas turbine, the sign detection device comprising:
a first index calculation part for calculating a first index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors;
a second index calculation part for calculating a second index indicating a synchronous property among a plurality of pieces of time-series data obtained from a second sensor and a third sensor disposed respectively at different positions of the combustor from one another; and
a sign detection part for detecting the sign on the basis of the first index and the second index.

2. The sign detection device according to claim 1,
wherein the sign detection part is configured to identify a class corresponding to the sign by applying a classification model to past data of the first index or the second index and detect the sign on the basis of whether the first index or the second index belongs to the class.

3. The sign detection device according to claim 1,
wherein the first index calculation part is configured to calculate the first index indicating the regression property as a parameter indicating a ratio of a regression point constituting a diagonal structure included in a recurrence plot corresponding to the plurality of multi-dimensional vectors to all regression points.

4. The sign detection device according to claim 1,
wherein the first index calculation part is configured to calculate the first index indicating the intermittency property as a parameter indicating a ratio of a regression point constituting a vertical structure or a horizontal structure included in a recurrence plot corresponding to the plurality of multi-dimensional vectors to all regression points.

5. The sign detection device according to claim 1,
wherein the second index calculation part is configured to calculate the second index as at least one of an order parameter obtained from the plurality of pieces of time-series data, a parameter indicating a ratio of a regression point forming a diagonal structure included in a joint recurrence plot obtained from the plurality of pieces of time-series data to all regression points, or a parameter indicating a ratio of a regression point forming a diagonal structure included in a cross recurrence plot obtained from the plurality of pieces of time-series data to all regression points.

6. The sign detection device according to claim 1,
wherein the second sensor and the third sensor are disposed along a circumferential direction with respect to a center axis of the combustor.

7. A sign detection method for detecting a sign of oscillation generated in a combustor of a gas turbine, the sign detection method comprising:
a step of calculating a first index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors;
a step of calculating a second index indicating a synchronous property among a plurality of pieces of time-series data obtained from a second sensor and a third sensor disposed respectively at different positions of the combustor from one another; and
a step of detecting the sign on the basis of the first index and the second index.

8. A sign detection program for detecting a sign of oscillation generated in a combustor of a gas turbine, the sign detection program capable of performing, with a computer apparatus:
a step of calculating a second index indicating at least one of a regression property among a plurality of multi-dimensional vectors including, as vector components, multiple pieces of data included in time-series data obtained from a first sensor disposed on the combustor, or an intermittency property among the plurality of multi-dimensional vectors;
a step of calculating a second index indicating a synchronous property among a plurality of pieces of time-series data obtained from a second sensor and a third sensor disposed respectively at different positions of the combustor from one another; and
a step of detecting the sign on the basis of the first index and the second index.
